(19) United States
(12) Patent Application Publication
(10) Pub. No.: US 2026/0311660 A1
(43) Pub. Date: Oct. 8, 2026

(54) ELECTRONIC DEVICE AND METHOD FOR CONTROLLING BRIGHTNESS OF ALWAYS ON DISPLAY CONTENT, AND STORAGE MEDIUM

(71) Applicant: Samsung Electronics Co., Ltd., Suwon-si (KR)

(72) Inventors: Yeojin MOON, Suwon-si (KR); Hanyuool KIM, Suwon-si (KR)

(21) Appl. No.: 19/703,746

(22) Filed: Jun. 10, 2026

Related U.S. Application Data
(63) Continuation of application No. PCT/KR2024/018359, filed on Nov. 20, 2024.

(30) Foreign Application Priority Data
Jan. 2, 2024 (KR) 10-2024-0000440
Jan. 30, 2024 (KR) 10-2024-0013907

(51) Int. Cl. G09G 5/10; G09G 5/02

(52) U.S. Cl. CPC G09G 5/10; G09G 5/02; G09G 2320/046; G09G 2320/0626; G09G 2320/0666; G09G 2360/144; G09G 2360/16

(57) ABSTRACT

An electronic device and a method for controlling the brightness of always on display content, and a storage medium are provided. The method includes detecting ambient illuminance, identifying a maximum value among a red (R) value, a green (G) value, and a blue (B) value of the content, acquiring a difference value by comparing an RGB-value of a reference table corresponding to the detected ambient illuminance with the identified maximum value, adjusting the R value, the G value, and the B value of the content based on the acquired difference value, and displaying the content, the R-value, the G-value, and the B-value of which have been adjusted, as the always on display content on a display.

### CROSS-REFERENCE TO RELATED APPLICATIONS

This application is a continuation application, claiming priority under 35 U.S.C. § 365(c), of an International application No. PCT/KR2024/018359, filed on Nov. 20, 2024, which is based on and claims the benefit of a Korean patent application number 10-2024-0000440, filed on Jan. 2, 2024, in the Ministry of Intellectual Property (MOIP), and of a Korean patent application number 10-2024-0013907, filed on Jan. 30, 2024, in the Ministry of Intellectual Property (MOIP), the disclosure of each of which is incorporated by reference herein in its entirety.

### BACKGROUND

### 1. Field

The disclosure relates to an electronic device, a method, and a storage medium. More particularly, the disclosure relates to an electronic device, a method, and a storage medium for controlling the brightness of always-on-display content.

### 2. Description of Related Art

Electronic devices may power off components in a standby state in order to reduce power consumption. However, recent displays of high specification may enable electronic devices to display content even in a standby state for improved user convenience. Content displayed in the standby state may be always-on display content. For example, the content may include images, icons, text, and/or widgets. The brightness of content displayed on electronic devices may be appropriately adjusted to increase visibility while preventing display burn-in.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a storage medium for controlling the brightness of always-on-display content that control brightness according to characteristics of the content in consideration of the ambient brightness.

Additional aspects will be set forth in part in the description which follows and, in part, will be apparent from the description, or may be learned by practice of the presented embodiments.

In accordance with an aspect of the disclosure, a method for controlling the brightness of always-on-display content is provided. The method includes detecting an ambient illuminance, identifying a maximum value among a red (R) value, a green (G) value, and a blue (B) value of the content, acquiring a difference value by comparing the RGB value of a reference table corresponding to the detected ambient illuminance with the identified maximum value, adjusting the R value, the G value, and the B value of the content, based on the acquired difference value, and displaying the content, the R value, the G value, and the B value of which have been adjusted, as the always-on-display content on a display.

In accordance with another aspect of the disclosure, an electronic device is provided. The electronic device includes a sensor configured to detect ambient illuminance, a display, at least one processor, and memory including one or more storage media, storing instructions, wherein the instructions, when executed by the at least one processor individually or collectively cause the electronic device to identify a maximum value among a red (R) value, a green (G) value, and a blue (B) value of content, acquire a difference value by comparing an RGB value of a reference table corresponding to the detected ambient illuminance with the identified maximum value, adjust the R value, the G value, and B value of the content, based on the acquired difference value, and display the content, the R value, G value, and B value of which have been adjusted, as the always-on-display content on the display.

In accordance with another aspect of the disclosure, one or more non-transitory computer-readable storage media storing one or more computer programs including computer-executable instructions that, when executed by one or more processors of a method for controlling the brightness of always-on-display content individually or collectively, cause the method to perform operations are provided. The operations include detecting ambient illuminance, identifying a maximum value among a red (R) value, a green (G) value, and a blue (B) value of the content, acquiring a difference value by comparing an RGB value of a reference table corresponding to the detected ambient illuminance with the identified maximum value, adjusting the R value, G value, and B value of the content, based on the acquired difference value, and displaying the content, the R value, the G value, and the B value of which have been adjusted, as always-on-display content on a display.

Various embodiments of the disclosure control the brightness of content according to the ambient brightness. In addition, various embodiments of the disclosure control the brightness of content in consideration of the characteristics of the content.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram for describing the configuration of an electronic device according to an embodiment of the disclosure;

FIGS. 3A, 3B, and 3C are diagrams for describing a reference table according to various embodiments of the disclosure;

FIG. 4 is a diagram for describing the maximum value of RGB of content according to an embodiment of the disclosure;

FIG. 5 is a flowchart illustrating a process of determining a reference RGB value according to the area of content according to an embodiment of the disclosure;

FIGS. 6A, 6B, 6C, and 6D are flowcharts illustrating a process for controlling the brightness of content when the area of content is less than a first predetermined ratio according to various embodiments of the disclosure;

FIGS. 7A, 7B, 7C, and 7D are flowcharts illustrating a process of controlling the brightness of content when the area of content is equal to or larger than a first predetermined ratio and smaller than a second predetermined ratio according to various embodiments of the disclosure;

FIGS. 8A, 8B, 8C, and 8D are flowcharts illustrating a process of controlling the brightness of content when the area of content is equal to or greater than a second predetermined ratio according to various embodiments of the disclosure;

FIG. 9 is a diagram for describing the relationship between ambient illuminance and mask transparency according to an embodiment of the disclosure;

FIG. 10 is a diagram for describing a method of displaying multiple pieces of content according to an embodiment of the disclosure;

FIGS. 11A and 11B are diagrams for describing a method of masking multiple pieces of content according to various embodiments of the disclosure; and

FIG. 12 is a flowchart illustrating a method of controlling the brightness of always-on-display content according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

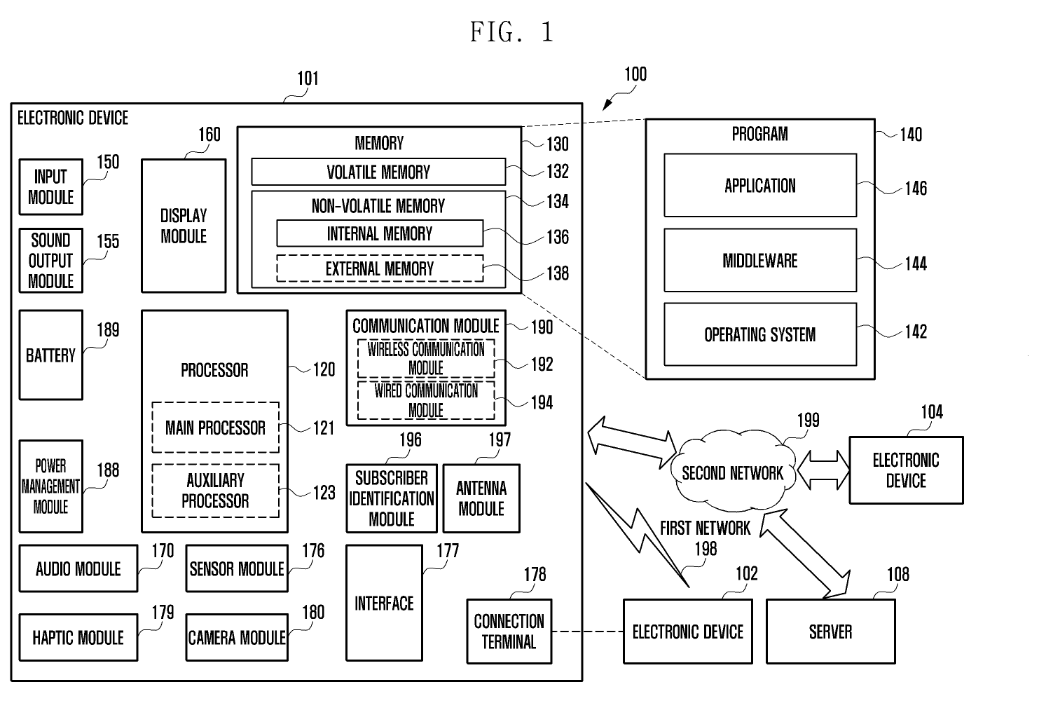

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an example, the electronic device 101 may communicate with the electronic device 104 via the server 108. According to an example, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some examples, at least one of the components (e.g., the connection terminal 178) may be omitted from the electronic device 101, or one or more other components may be added in the electronic device 101. In some examples, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one example, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an example, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an example, the auxiliary processor 123 (e.g., an image signal processor or a communication processor) may be implemented as part of another component (e.g., the camera module 180 or the communication module 190) functionally related to the auxiliary processor 123. According to an example, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory may include at least one of an internal memory 136 and an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an example, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an example, the display module 160 may include a touch sensor adapted to detect a touch, or a pressure sensor adapted to measure the intensity of force incurred by the touch.

The audio module 170 may convert a sound into an electrical signal and vice versa. According to an example, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an example, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an example, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an example, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an example, the haptic module 179 may include, for example, a motor, a piezoelectric element, or an electric stimulator.

The camera module 180 may capture a still image or moving images. According to an example, the camera module 180 may include one or more lenses, image sensors, image signal processors, or flashes.

The power management module 188 may manage power supplied to the electronic device 101. According to one example, the power management module 188 may be implemented as at least part of, for example, a power management integrated circuit (PMIC).

The battery 189 may supply power to at least one component of the electronic device 101. According to an example, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an example, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an example, the wireless communication module 192 may support a peak data rate (e.g., 20 gigabits per second (Gbps) or more) for implementing eMBB, loss coverage (e.g., 164 decibels (dB) or less) for implementing mMTC, or user plane (U-plane) latency (e.g., 0.5 milliseconds (ms) or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an example, the antenna module 197 may include an antenna including a radiating element composed of a conductive material or a conductive pattern formed in or on a substrate (e.g., a printed circuit board (PCB)). According to an example, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an example, another component (e.g., a radio frequency integrated circuit (RFIC)) other than the radiating element may be additionally formed as part of the antenna module 197.

According to various examples, the antenna module 197 may form an mmWave antenna module. According to an example, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an example, all or some of operations to be executed at the electronic device 101 may be executed at one or more of the external electronic devices (e.g. electronic devices 102 and 104 or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example, the external electronic device 104 may include an internet-of-things (IoT) device. The server 108 may be an intelligent server using machine learning and/or a neural network. According to an example, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various examples may be one of various types of electronic devices. The electronic devices may include, for example, a portable communication device (e.g., a smartphone), a computer device, a portable multimedia device, a portable medical device, a camera, a wearable device, or a home appliance. According to an example of the disclosure, the electronic devices are not limited to those described above.

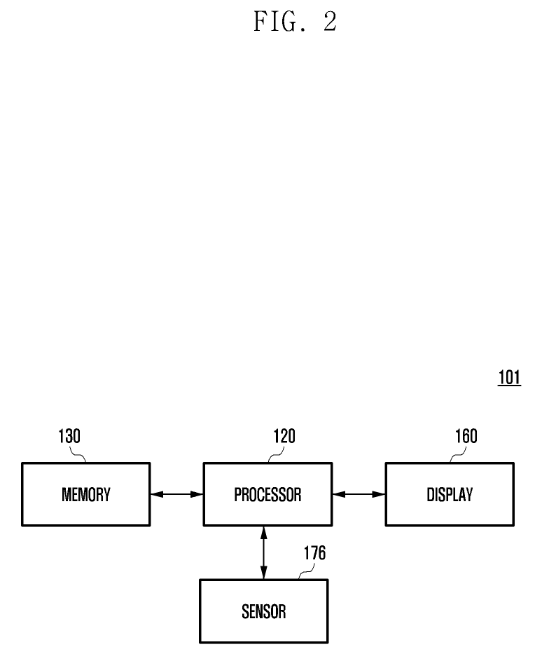

FIG. 2 is a block diagram for describing the configuration of an electronic device according to an embodiment of the disclosure.

Referring to FIG. 2, the electronic device 101 may include a sensor 176, a display 160, memory 130, and a processor 120.

The sensor 176 (the sensor module 176 in FIG. 1) may detect the ambient illuminance of the electronic device 101 (e.g., the electronic device 101 in FIG. 1). For example, the sensor 176 may include an illuminance sensor. The display 160 (e.g., the display module 160 in FIG. 1) may constantly display content in a standby state. The brightness of the display 160 may be adjusted under the control of the processor 120 (e.g., the processor in FIG. 1), based on the ambient illuminance detected by the sensor 176.

The memory 130 (e.g., the memory 130 in FIG. 1) may store data, algorithms, programs, instructions, and the like for performing functions of the electronic device 101. The instructions stored in the memory 130 may be loaded into the processor 120 and executed by the processor 120. For example, the memory 130 may store content to be displayed constantly and a reference table for comparing the red, green, and blue (RGB) values of the content. For example, the content may include images, text, icons, and/or widgets. In addition, the constantly displayed content may include a background image. The reference table may include RGB values corresponding to the luminance of the display 160 according to the ambient illuminance. The RGB values included in the reference table may include RGB values of the white color recognized according to the luminance of the display 160. In addition, the RGB values included in the reference table may include value equal to or less than a maximum value that prevents (does not generate) burn-in and/or afterimages of the display 160.

The processor 120 may control each component of the electronic device 101. The electronic device 101 may include one or more processors 120. For example, the processor 120 may correspond to multiple processors which collectively perform multiple functions by dividing the functions among the processors.

The processor 120 may control the display 160 to constantly display content in the standby state according to the user’s input. The processor 120 may control the sensor 176 to detect ambient illuminance.

The processor 120 may identify the maximum value among the red (R) value, green (G) value, and blue (B) value of content. For example, if the content includes a single color, the processor 120 may identify the color code of the content and determine the RGB value of the identified color code as the RGB value of the content. In addition, the processor 120 may identify the largest value among the identified RGB values as the maximum value. As an example, if the content includes a single color of SeaGreen, the processor 120 may identify the color code of the content as #2E8B57. In addition, the processor 120 may determine R value 46, G value 139, and B value 87 from the identified color code #2E8B57. Since the G value of among the RGB values is 139, which is the largest, the processor 120 may identify the maximum value of the content RGB as the G value of 139. As an example, if the content includes multiple colors, the processor 120 may identify the RGB value of each pixel of the content. In addition, the processor 120 may identify the largest value among all the identified RGB values as the maximum value of the content RGB value.

The processor 120 may compare the RGB value of the reference table corresponding to the detected ambient illuminance with the identified maximum value to acquire a difference value. As an example, if the RGB values of the reference table corresponding to the ambient illuminance are 43, 43, and 43, respectively, the processor 120 may acquire -96 (for example, 43 - 139) as a difference value. As an example, if the RGB values of the reference table corresponding to the ambient illuminance are 204, 204, and 204, respectively, the processor 120 may acquire 65 (e.g., 204-139) as a difference value.

For example, the reference table may include multiple reference tables including different RGB values according to the area (or size) of content. The processor 120 may identify the area of the content. The processor 120 may determine one reference table corresponding to the area of the content, among multiple reference tables, based on the area of the content. In addition, the processor 120 may determine the RGB value corresponding to the ambient illuminance included in the determined single reference table. The processor 120 may compare the RGB value of the determined reference table and the maximum value of the identified content, and acquire a difference value.

The processor 120 may adjust the R value, G value, and B value of the content, based on the acquired difference value. As an example, upon requiring -96 as the difference value, the processor 120 may add -96 to all RGB values of the content (or subtract 96 therefrom). As an example, upon acquiring 65 as the difference value, the processor 120 may 65 to all RGB values of the content.

The processor 120 may display the content, the R value, G value, and B value of which have been adjusted, on the display 160 as always-on-display content. Since the RGB value of the content is adjusted at the same ratio as a whole, the processor 120 may control the brightness of the content to a brightness corresponding to the ambient illuminance while maintaining the tone and/or atmosphere of the content.

Multiple pieces of content may be displayed always. Multiple pieces of content may be displayed as different layers. The processor 120 may identify the maximum value of the content RGB values with regard to each of the multiple pieces of content. The processor 120 may acquire a difference value by comparing the RGB values of the reference table corresponding to the multiple pieces of content, respectively, and the maximum value of the content. The processor 120 may control the brightness of the content by applying the difference value to the RGB of the content with regard to each of the multiple pieces of content.

The processor 120 may move the content to prevent burn-in and/or afterimages of the display 160 while constantly displaying the content. For example, as the size of the content becomes smaller, the processor 120 may move the content to a larger space, and as the size of the content becomes larger, the processor 120 may move the content in a narrow space. As an example, the processor 120 may move the displayed content by a preconfigured distance at a preconfigured time interval. As an example, if the ambient illuminance is less than or equal to a specific value, the adjusted brightness of the content is also less than or equal to a specific value, and the display 160 may thus not experience burn-in and/or afterimages. Therefore, if the ambient illuminance is less than (or equal to) a specific value, the processor 120 may maintain the current position of the content without moving the content. As an example, if the ambient illuminance is 500 lux or less, the processor 120 may not move the content, and if the ambient illuminance exceeds 500 lux, the processor 120 may move the content according to the preconfigured time and distance.

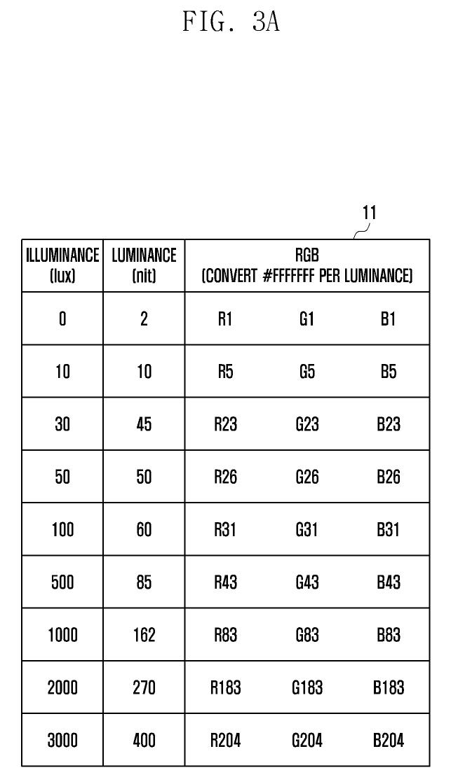

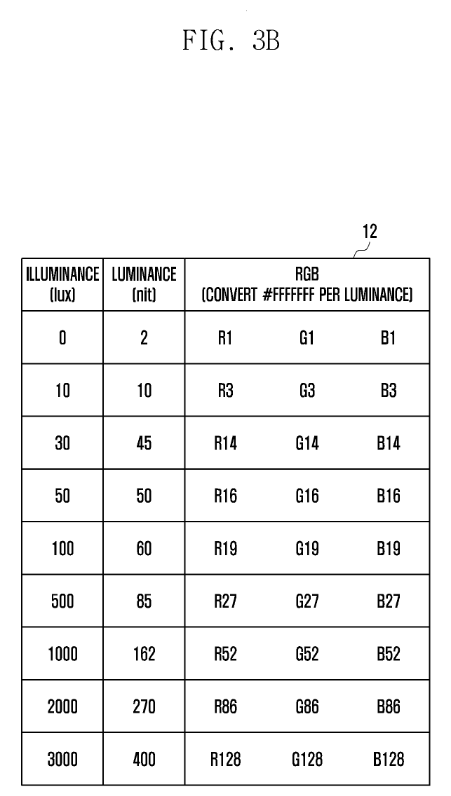

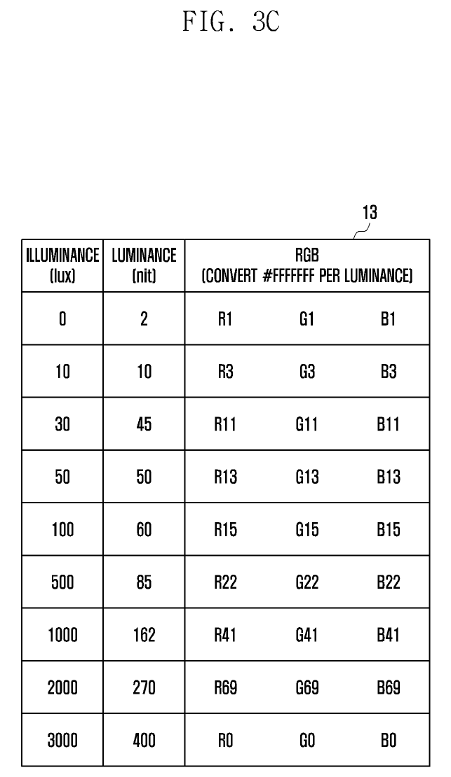

FIGS. 3A, 3B, and 3C are diagrams for describing a reference table according to various embodiments of the disclosure.

FIG. 3A illustrates a first reference table 11 corresponding to a case in which the area of content is smaller than a first size, FIG. 3B illustrates a second reference table 12 corresponding to a case in which the area of content is equal to or greater than the first size and smaller than a second size, and FIG. 3C illustrates a third reference table 13 corresponding to a case in which the area of content is equal to or greater than the second size.

For example, each of the reference tables 11, 12, and 13 may include the luminance of the display 160 according to the ambient illuminance. In addition, each of the reference tables 11, 12, and 13 may include the RGB value of white color displayed according to the luminance of the display 160. The reference tables 11, 12, and 13 may include different RGB values under the same condition according to the area of content. As an example, the first size of content area may correspond to 20% of the screen area of the display 160, and the second size of content area may correspond to 40% of the screen area of the display 160. As an example, if the ambient illuminance is 100 lux in the first table 11, the luminance of the display 160 may be 60 nit, and the RGB value of the displayed white color may be 31, 31, 31. If the ambient illuminance is 100 lux in the second table 12, the luminance of the display 160 may be 60 nit, and the RGB value of the displayed white color may be 19, 19, 19. If the ambient illuminance is 100 lux in the third table 13, the RGB value of the displayed white color may be 15, 15, 15. The RGB values included in respective reference tables 11, 12, and 13 may include value equal to or less than the maximum which may prevent burn-in and/or afterimages of the display 160.

As an example, if the area of the content is less than a first size (e.g., the content area corresponds to 15% of the screen area), the corresponding first reference table 11 may include an RGB value of 204 or less. If the area of the content is equal to or larger than the first size and less than a second size (e.g., the content area corresponds to 35% of the screen area), the corresponding second reference table 12 may include an RGB value of 128 or less. If the area of the content is equal to or larger than the second size (e.g., the content area corresponds to 75% of the screen area), the corresponding third reference table 13 may include an RGB value of 69 or less. The electronic device 101 may move content that is displayed constantly in order to prevent burn-in and/or afterimages of the display 160. The smaller the area of the content, the larger the space of movement space of the content may be. The electronic device 101 may move the content to a larger space as the area of the content is smaller to prevent burn-in and/or afterimages of the display 160, and thus may display the content relatively bright. Conversely, the electronic device 101 may make the space of movement of the content smaller as the area of the content is larger. Since there is a limit to the electronic device 101 moving the content in order to prevent burn-in and/or afterimages of the display 160, the content may be displayed relatively dark.

As an example, if the ambient brightness is very bright (e.g., about 3000 lux or more), the content displayed on the display 160 may be difficult for the user to recognize. In addition, the larger the area of the displayed content, the higher the power consumption may be. If the content area is equal to or larger than a second size (e.g., the content area corresponds to 60% of the screen area), and if the ambient illuminance is ultra-high illuminance, the electronic device 101 may adjust the RGB value of the content to 0 in order to reduce the current consumption due to the display of the content that is difficult to recognize. In other words, the electronic device 101 may delete the content (e.g., delete the background image).

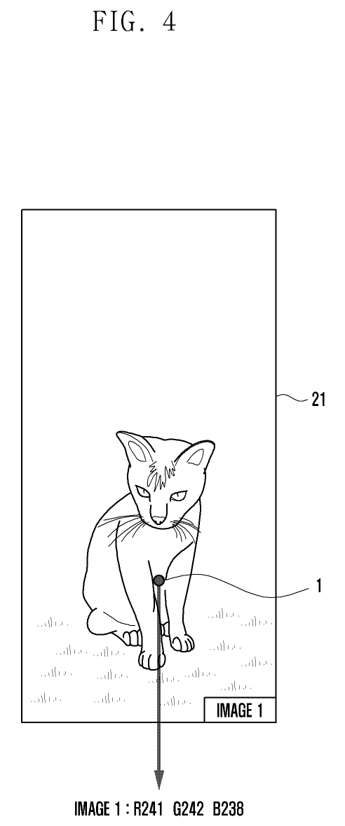

FIG. 4 is a diagram for describing the maximum value of RGB of content according to an embodiment of the disclosure.

Referring to FIG. 4, content 21 to be displayed constantly is displayed. The electronic device 101 may identify the maximum value among the RGB values of each pixel of the content. As an example, the content 21 may be an image. If the content 21 is an image, the content 21 may include various shapes and colors. Depending on various colors, respective pixels of the content 21 may include different RGB values.

For example, the electronic device 101 may acquire the RGB values of all the pixels of the content 21, and identify the largest value among the acquired RGB values as the maximum value of the content 21 RGB. For example, since the RGB values of a bright color (e.g., white) include a high value, the electronic device 101 may search for a region including a bright color in the content 21, acquire the RGB values of each pixel included in the searched region, and identify the maximum value. For example, the electronic device 101 may acquire the R value, the G value, and the B value of each pixel included in the analysis region (e.g., the entire region or the searched region) of the content, and identify the largest value among all the acquired R, G, and B values as the maximum value. For example, the electronic device 101 may compare the RGB sum value of respective pixels of the analysis region of the content, thereby identifying the pixel having the largest sum value, and may identify the largest value among the R, G, and B values of the identified pixel as the maximum value.

As an example, as illustrated in FIG. 4, the RGB value of the first pixel 1 may be the maximum RGB value, and the RGB values of the first pixel 1 may be 241, 242, and 238, respectively. The electronic device 101 may identify the G value (e.g., 242) among the RGB values of the first pixel 1 as the maximum value of the RGB of the content 21.

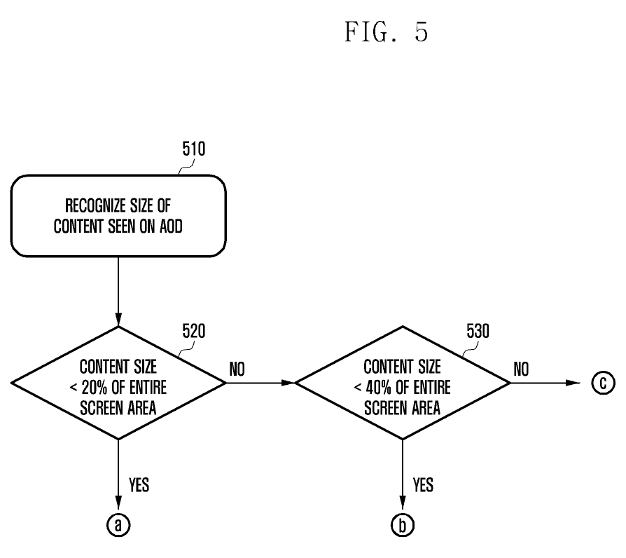

FIG. 5 is a flowchart illustrating a process of determining a reference RGB value according to the area of content according to an embodiment of the disclosure.

In the following embodiments, respective operations may be performed in sequence, but are not necessarily performed in sequence. For example, the order of respective operations may be changed, and at least two operations may be performed in parallel.

According to an embodiment, 510 to 530 may be understood as being performed by a processor (e.g., the processor 120 in FIG. 2) of an electronic device (e.g., the electronic device 101 in FIG. 2).

Referring to FIG. 5, the electronic device 101 may recognize the size (or area) of content displayed on an always-on display (AOD) at operation 510. For example, the content displayed on the AOD may be content that is displayed constantly in a standby state. The content may be displayed on a layer. The electronic device 101 may recognize the size of the layer on which the content is displayed as the size of the content.

For example, if the content displayed constantly includes first, second, and third pieces of content, the first content may be displayed on a first layer of a first size, the second content may be displayed on a second layer of a second size, and the third content may be displayed on a third layer of a third size. The content included in each layer may be redundantly displayed. For example, the second content included in the second layer and the third content included in the third layer may be displayed above the first content included in the first layer. Alternatively, the second content included in the second layer may be displayed above the first content included in the first layer, and the third content included in the third layer may be displayed above the second content.

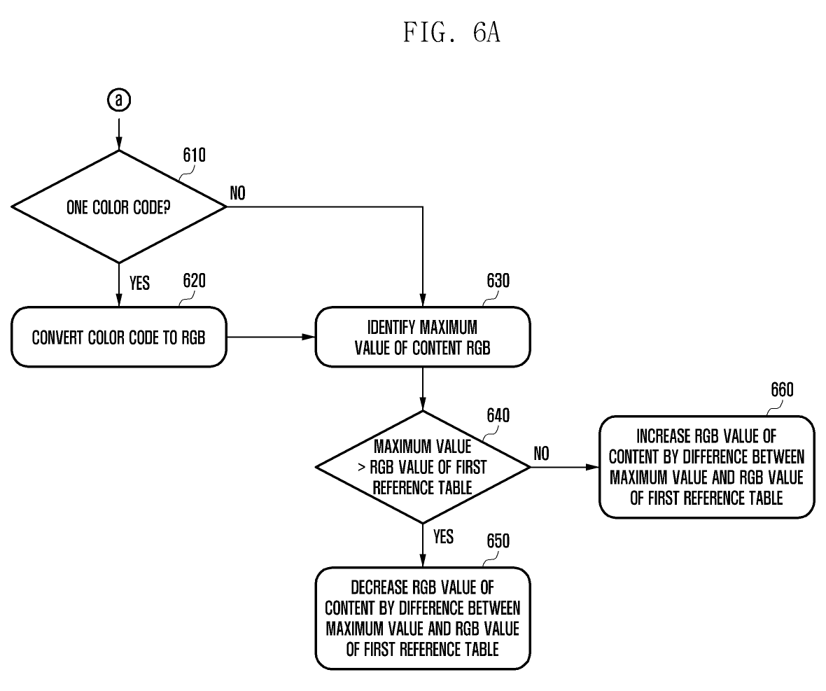

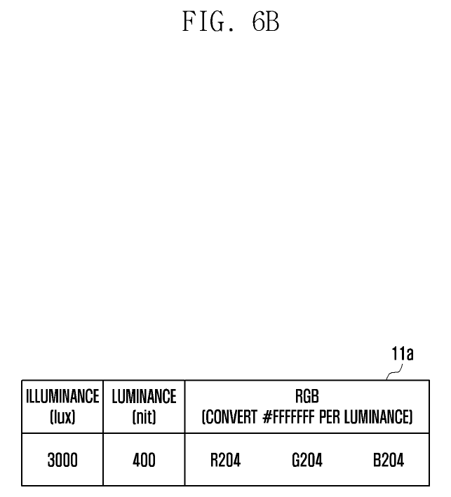

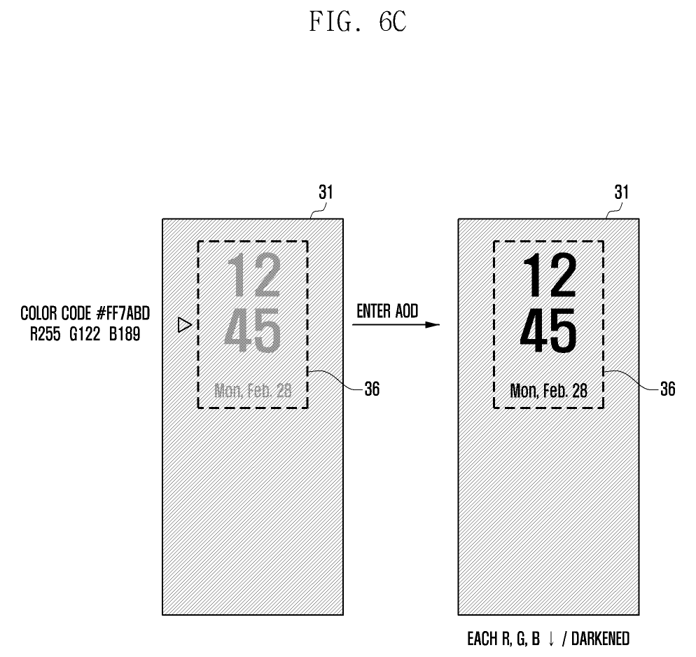

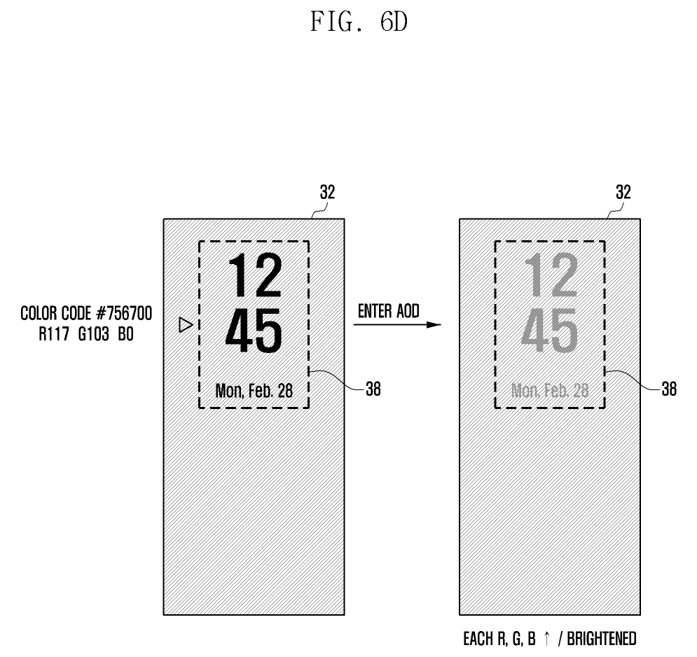

The electronic device 101 may determine whether the size of the content is smaller than the first size. For example, the electronic device 101 may determine whether the content size is less than 20% of the entire screen area at operation 520. If the size of the content is less than the first size (e.g., 20% of the full screen area) at operation 520-Y, the electronic device 101 may perform process (a) to be described in FIG. 6A.

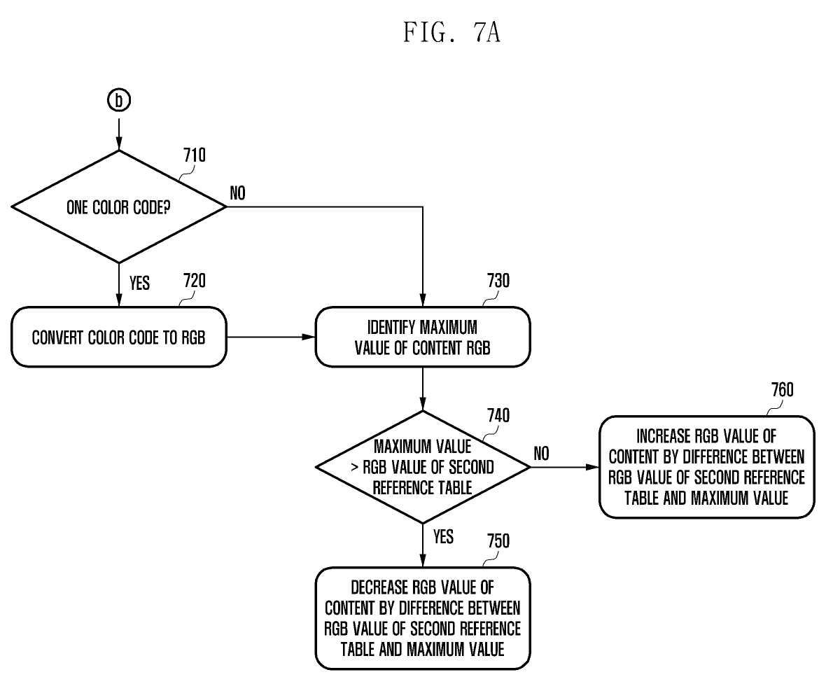

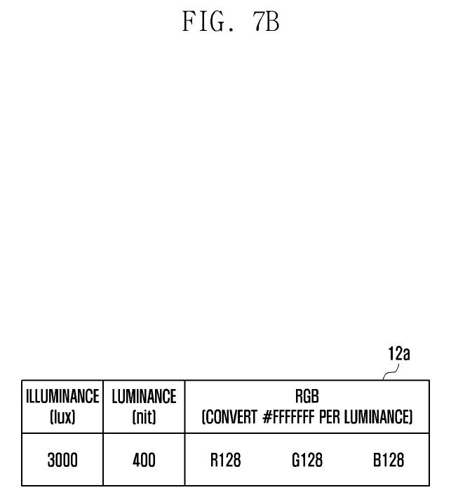

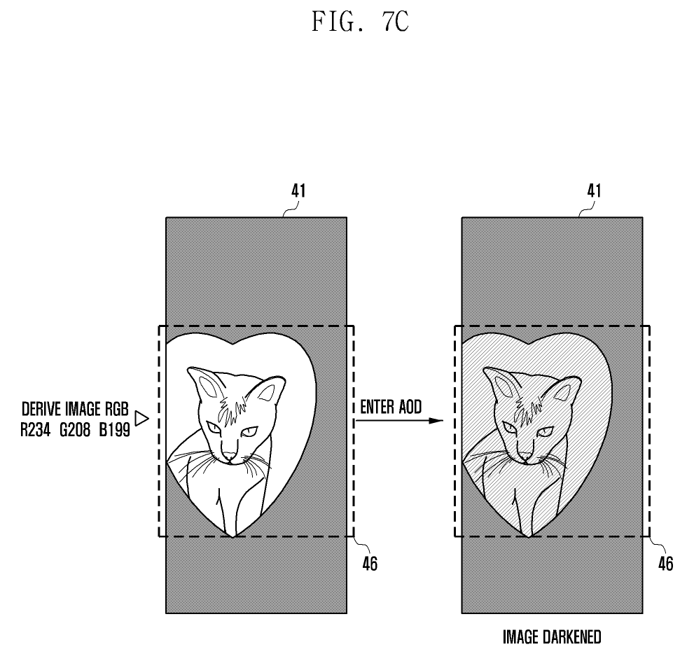

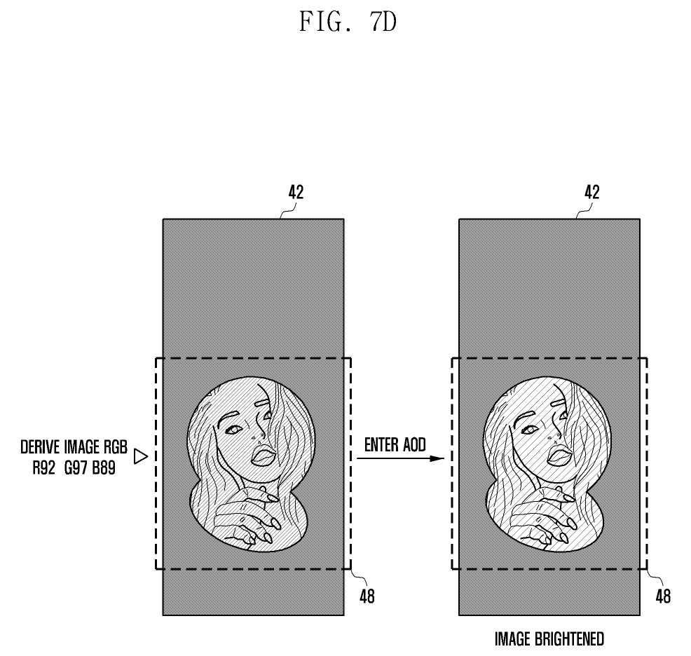

If the size of the content is equal to or larger than the first size (e.g., 20% of the entire screen area) at operation 520-N, the electronic device 101 may determine whether the size of the content is smaller than a second size. As an example, the electronic device 101 may determine whether the size of the content is less than 40% of the entire screen area at operation 530. If the size of the content is less than the second size (for example, 40% of the entire screen area) at operation 530-Y, the electronic device 101 may perform process (b) to be described in FIG. 7A.

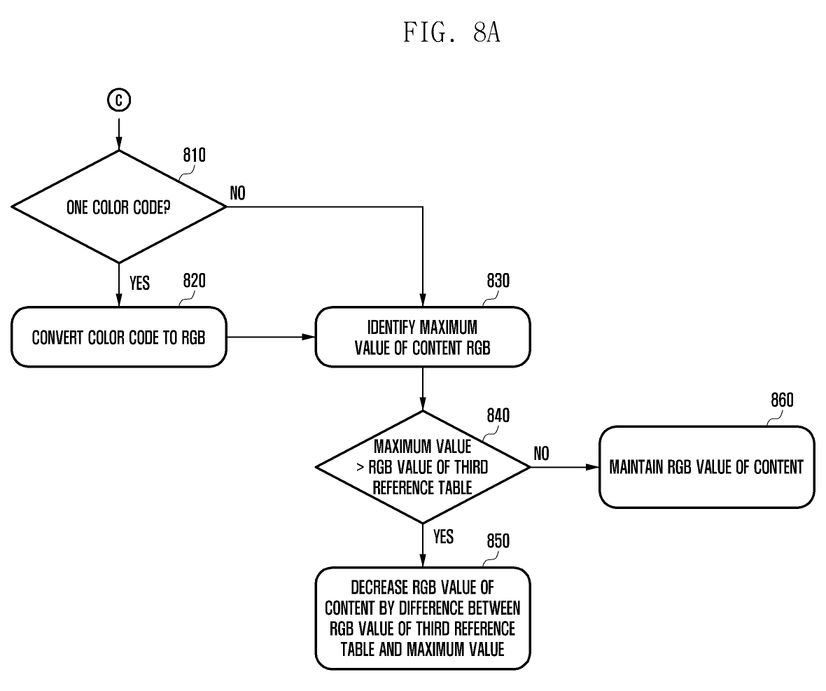

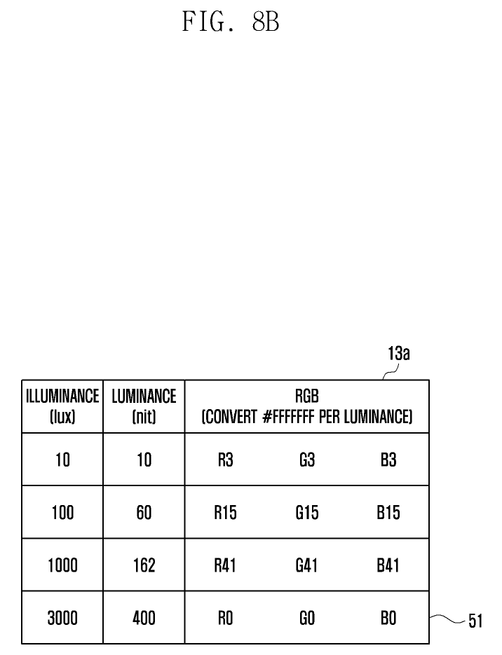

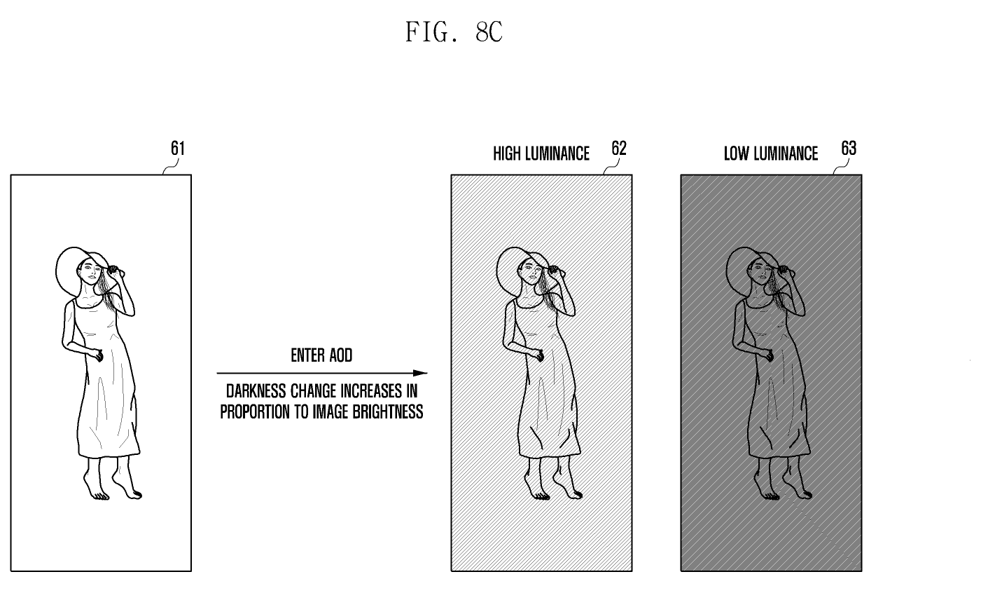

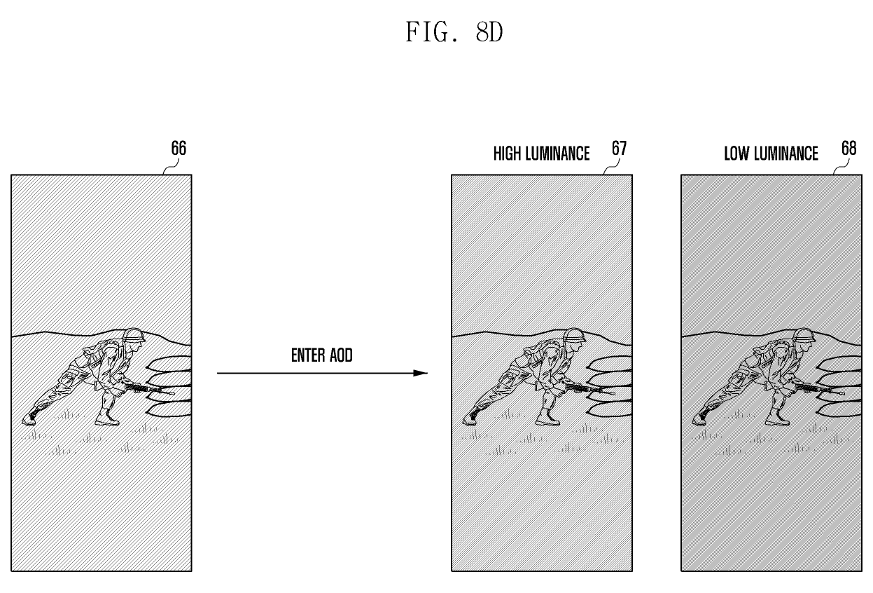

If the size of the content is equal to or larger than the second size (e.g., 40% of the entire screen area) at operation 530-N, the electronic device 101 may perform the processes to be described in FIG. 8A.

FIGS. 6A, 6B, 6C, and 6D are diagrams for describing a process of controlling the brightness of content when the area of the content is less than a first preconfigured ratio according to various embodiments of the disclosure.

Referring to FIG. 6A, a flowchart for describing a process of controlling the brightness of content when the area of the content is less than a first preconfigured ratio is illustrated.

In the following embodiments, respective operations may be performed in sequence, but are not necessarily performed in sequence. For example, the order of respective operations may be changed, and at least two operations may be performed in parallel.

According to an embodiment, operations 610 to 660 may be understood as being performed by a processor (e.g., the processor 120 in FIG. 2) of an electronic device (e.g., the electronic device 101 in FIG. 2).

If the area of the content is less than a first preconfigured ratio (e.g., less than 20% of the entire screen area), the electronic device 101 may determine whether the content includes one color code at operation 610. For example, if the content includes a single color, the content may include one color code.

If the content includes one color code at operation 610-YES, the electronic device 101 may convert the color code to RGB at operation 620. As an example, if the content includes a single color of SeaGreen, the electronic device 101 may determine that the content includes one color code. In addition, the electronic device 101 may identify the color code of the content as #2E8B57. The electronic device 101 may convert the identified color code #2E8B57 to an R value of 46, a G value of 139, and a B value of 87. The electronic device 101 may identify the maximum value of the RGB of the content, based on the converted RGB values at operation 630. As an example, the electronic device 101 may identify a G value 139 as the maximum value of the RGB of the content.

If the content includes multiple colors, the content may include multiple color codes. If the content includes multiple color codes at operation NO in 610, the electronic device 101 may identify the maximum value of RGB from the pixel of the content at operation 630. For example, the electronic device 101 may acquire RGB values of all pixels of the content, and identify the largest value among the acquired RGB values as the maximum value of the content RGB. For example, since the RGB value of a bright color (e.g., white) includes a high value, the electronic device 101 may search for a region including a bright color in the content, and identify the maximum value from the RGB values of each pixel included in the searched region. For example, the electronic device 101 may acquire the R value, the G value, and the B value of each pixel included in the analysis region (e.g., the entire region or searched region of the content, and identify the largest value among all acquired R values, G values, and B values as the maximum value. For example, the electronic device 101 may compare the RGB sum values of respective pixels of the content analysis region, thereby identifying the pixel having the largest sum, and may identify largest value among the R, G, and B values of the identified pixel as the maximum value.

The electronic device 101 may compare the maximum value of the RGB of the content with the RGB value of the first reference table 11a at operation 640. For example, if the size of the content is smaller than the first size (e.g., 20% of the entire screen area), the electronic device 101 may compare the maximum value of the RGB of the content with the RGB value of the first reference table 11a. The electronic device 101 may compare the RGB value corresponding to the detected ambient illuminance among RGB values of the first reference table 11a with the maximum value of the RGB of the content. For example, as shown in FIG. 6B, if the detected ambient illuminance is about 3000 lux or more, the corresponding RGB values of the first reference table 11a may be 204, 204, and 204, respectively. The electronic device 101 may compare the maximum value of the RGB value of the content with the RGB value 204 included in the first reference table 11a.

If the maximum value of the RGB of the content is greater than the RGB value of the first reference table 11a at operation YES in 640, the electronic device 101 may reduce the RGB value of the content by the difference between the RGB value of the first reference table 11a and the RGB value of the content at operation 650.

FIG. 6C shows first content 36 displayed on the screen 31. For example, the color code of the first content 36 may be #FF7ABD, and the electronic device 101 may convert the color code to an R value of 255, a G value of 122, and a B value of 189. The electronic device 101 may identify the maximum value of the RGB value of the first content 36 as the R value 255 from the converted RGB values. The electronic device 101 may compare the RGB values of the first reference table 11a with the RGB values of the first content 36, and determine a difference value of -51 (e.g., 204-255).

The electronic device 101 may adjust the brightness of the first content 36 by applying the difference value to the RGB value of the first content 36. For example, the electronic device 101 may adjust RGB values of 255, 122, and 189 of the first content 36 to 204, 71, and 138 in consideration of the difference value of -51. As an example, if the first content 36 includes a single color, the electronic device 101 may adjust all pixels of the first content 36 to have the same value. For example, if the first content 36 includes multiple colors, the electronic device 101 may add the same value (e.g., -51) to all R, G, and B values of each pixel of the first content 36 (or may subtract 51 therefrom). If the electronic device 101 enters the AOD mode, the electronic device 101 may display the first content 36, the RGB values of which have been adjusted, on the screen 31 as always-on-display content. Since the RGB values of the first content 36 have decreased in the AOD mode, the region of the first content 36 may become darker than before.

If the maximum value of the RGB of the content is smaller than the RGB value of the first reference table 11a at operation NO in 640, the electronic device 101 may increase the RGB value of the content by the difference between the RGB value of the first reference table 11a and the RGB value of the content at operation 660.

FIG. 6D illustrates second content 38 displayed on the screen 32. For example, the color code of the second content 38 may be #756700, and the electronic device 101 may convert the color code to an R value of 117, a G value of 103, and a B value of 0. The electronic device 101 may identify the maximum value of the RGB value of the second content 38 as R value 117 from the converted RGB values. The electronic device 101 may compare the RGB values of the first reference table 11a and the RGB values of the second content 38 and determine a difference value of 87 (for example, 204-117).

The electronic device 101 may adjust the brightness of the second content 38 by applying the difference value to the RGB value of the second content 38. For example, the electronic device 101 may adjust 117, 103, and 0 of the second content 38 to 204, 190, and 87 in consideration of the difference value of 87. As an example, if the second content 38 includes a single color, the electronic device 101 may adjust all pixels of the second content 38 to the same value. As an example, if the second content 38 includes multiple colors, the electronic device 101 may add the same value (e.g., 87) to all R values, G values, and B values of each pixel of the second content 38. If the electronic device 101 enters the AOD mode, the electronic device 101 may display the second content 38, the RGB values of which have been adjusted, on the screen 32 as always-on-display content. In the AOD mode, the entire screen 31 may be displayed dark as a whole, but since the RGB values of the second content 38 have increased, the region of the second content 38 may be brighter than before.

FIGS. 7A, 7B, 7C, and 7D are diagrams for describing a process of controlling the brightness of content when the area of content is equal to or larger than a first preconfigured ratio and smaller than a second preconfigured ratio according to various embodiments of the disclosure.

Referring to FIG. 7A, a flowchart is illustrated for describing a process of controlling the brightness of content when the area of the content is equal to or greater than a first preconfigured ratio and less than a second preconfigured ratio.

In the following embodiments, respective operations may be performed in sequence, but are not necessarily performed in sequence. For example, the order of respective operations may be changed, and at least two operations may be performed in parallel.

According to an embodiment, operations 710 to 760 may be understood as being performed by a processor (e.g., the processor 120 in FIG. 2) of an electronic device (e.g., the electronic device 101 in FIG. 2).

If the area of content is equal to or larger than a first preconfigured ratio (e.g., 20% of the entire screen area) and smaller than a second preconfigured ratio (e.g., 40% of the entire screen area), the electronic device 101 may determine whether the content includes one color code at operation 710.

If the content includes one color code at operation 710-YES, the electronic device 101 may convert the color code to RGB at operation 720. As an example, if the content includes a single color of SeaGreen, the electronic device 101 may determine that the content includes one color code. In addition, the electronic device 101 may identify the color code of the content as #2E8B57. The electronic device 101 may convert the identified color code #2E8B57 to R value 46, G value 139, and B value 87. The electronic device 101 may identify the maximum value of RGB of the content, based on the converted RGB values at operation 730. As an example, the electronic device 101 may identify G value 139 as the maximum value of the RGB of the content.

If the content includes multiple color codes at operation NO in 710, the electronic device 101 may identify the maximum value of RGB from pixels of the content at operation 730. For example, the electronic device 101 may acquire RGB values of all pixels of the content, and identify the largest value among the acquired RGB values as the maximum value of the content RGB. For example, since the RGB values of a bright color (e.g., white) include high values, the electronic device 101 may search for a region including a bright color in the content, and identify the maximum value from the RGB values of each pixel included in the searched region. For example, the electronic device 101 may acquire the R value, G value, and B value of each pixel included in the analysis region (e.g., the entire region or searched region) of the content, and identify the largest value among all acquired R, G, and B values as the maximum value. For example, the electronic device 101 may compare RGB sum values of respective pixels of the content analysis region, thereby identifying the pixel having the largest sum, and may identify the largest value among the R, G, and B values of the identified pixel as the maximum value.

The electronic device 101 may compare the maximum value of the RGB of the content with the RGB values of the second reference table 12a at operation 740. For example, if the size of the content is equal to or greater than a first size (for example, 20% of the entire screen area) and less than a second size (for example, 40% of the entire screen area), the electronic device 101 may compare the maximum value of the RGB of the content to the RGB values of the second reference table 12a. The electronic device 101 may compare the RGB value corresponding to the detected ambient illuminance among RGB values in the second reference table 12a with the maximum value of RGB of the content. For example, as illustrated in FIG. 7B, if the detected ambient illuminance is about 3000 lux or more, the corresponding RGB values of the second reference table 12a may be 128, 128, and 128, respectively. The electronic device 101 may compare the RGB value 128 included in the second reference table 12a and the maximum value of the RGB value of the content.

If the maximum value of the RGB of the content is greater than the RGB value of the second reference table 12a at operation 740-YES, the electronic device 101 may reduce the RGB value of the content by the difference between the RGB value of the second reference table 12a and the RGB value of the content at operation 750.

FIG. 7C illustrates third content 46 displayed on the screen 41. For example, the RGB values of the pixel including the maximum value of RGB of the third content 46 may be 234, 208, and 199, respectively. The electronic device 101 may identify the maximum value of the RGB value of the third content 46 as R value 234. The electronic device 101 may compare the RGB values of the second reference table 12a with the RGB values of the third content 46, and determine a difference value of -106 (e.g., 128-234). As an example, if the third content 46 includes a single color, the electronic device 101 may identify the color code of the single color. In addition, the electronic device 101 may convert the identified color code to an RGB value, and identify the maximum value of the RGB value of the third content 46 from the converted RGB value. The electronic device 101 may compare the identified maximum value with the RGB values of the second reference table 12a and determine the difference value.

The electronic device 101 may adjust the brightness of the third content 46 by applying the difference value to the RGB value of the third content 46. For example, the electronic device 101 may adjust the RGB values 234, 208, and 199 of the third content 46 to 128, 102, and 93 in consideration of the difference value of -106. As an example, if the third content 46 includes a single color, the electronic device 101 may adjust all pixels of the third content 46 to have the same value. As an example, if the third content 46 includes multiple colors, the electronic device 101 may add the same value (e.g., -106) to all R, G, and B values of each pixel of the third content 46 (or may subtract 106 therefrom). If the electronic device 101 enters the AOD mode, the electronic device 101 may display the third content 46, the RGB values of which have been adjusted, on the screen 41 as the always-on-display content. Since the RGB values of the third content 46 have decreased in the AOD mode, the region of the third content 46 may be darker than before.

If the maximum value of the RGB of the content is smaller than the RGB value of the second reference table 12a at operation 740-NO, the electronic device 101 may increase the RGB value of the content by the difference between the RGB value of the second reference table 12a and the RGB value of the content at operation 760.

FIG. 7D illustrates fourth content 48 displayed on the display 42. For example, the RGB values of the pixel including the maximum value of RGB of the fourth content 48 may be 92, 97, and 89, respectively. The electronic device 101 may identify the maximum value of the RGB values of the fourth content 48 as G value 97. The electronic device 101 may compare the RGB values of the second reference table 12a with the RGB values of the fourth content 48 and determine a difference value of 31 (for example, 128-97). As an example, if the fourth content 48 includes a single color, the electronic device 101 may identify the color code of the single color. In addition, the electronic device 101 may convert the identified color code to an RGB value, and identify the maximum value of the RGB values of the fourth content 48 from the converted RGB value. The electronic device 101 may compare the identified maximum value with the RGB value of the second reference table 12a and determine a difference value.

The electronic device 101 may adjust the brightness of the fourth content 48 by applying the difference value to the RGB value of the fourth content 48. For example, the electronic device 101 may adjust the RGB values 92, 97, and 89 of the fourth content 48 to 123, 128, and 120 in consideration of the difference value of 31. As an example, if the fourth content 48 includes a single color, the electronic device 101 may adjust all pixels of the fourth content 48 to the same value. As an example, if the fourth content 48 includes multiple colors, the electronic device 101 may add the same value (e.g., 31) to all R values, G values, and B values of each pixel of the fourth content 48. If the electronic device 101 enters the AOD mode, the electronic device 101 may display the fourth content 48, the RGB values of which have been adjusted, on the display 42 as always-on-display content. Since the RGB values of the fourth content 48 have increased in the AOD mode, the region of the fourth content 48 may be brighter than before.

FIGS. 8A, 8B, 8C, and 8D are diagrams for describing a process of controlling the brightness of content when the area of the content is equal to or larger than a second preconfigured ratio according to various embodiments of the disclosure.

Referring to FIG. 8A, a flowchart for describing a process of controlling the brightness of content when the area of the content is equal to or larger than a second preconfigured ratio is illustrated.

In the following embodiments, respective operations may be performed in sequence, but are not necessarily performed in sequence. For example, the order of respective operations may be changed, and at least two operations may be performed in parallel.

According to an embodiment, operations 810 to 860 may be understood as being performed by a processor (e.g., the processor 120 in FIG. 2) of an electronic device (e.g., the electronic device 101 in FIG. 2).

If the area of content is equal to or greater than a second preconfigured ratio (e.g., less than 40% of the entire screen area), the electronic device 101 may determine whether the content includes one color code at operation 810.

If the content includes one color code at operation 810-YES, the electronic device 101 may convert the color code to RGB at operation 820. As an example, if the content includes a single color of SeaGreen, the electronic device 101 may determine that the content includes one color code. In addition, the electronic device 101 may identify the color code of the content as #2E8B57. The electronic device 101 may convert the identified color code #2E8B57 to R value 46, G value 139, and B value 87. The electronic device 101 may identify the maximum value of the RGB of the content, based on the converted RGB values at operation 830. As an example, the electronic device 101 may identify G value 139 as the maximum value of the RGB of the content.

If the content includes multiple color codes at operation 810-NO, the electronic device 101 may identify the maximum value of RGB from the pixels of the content at operation 830. For example, the electronic device 101 may acquire RGB values of all pixels of the content, and identify the largest value among the acquired RGB values as the maximum value of the content RGB. For example, since the RGB value of a bright color (e.g., white) includes a high value, the electronic device 101 may search for a region including a bright color in the content, and identify the maximum value from the RGB values of each pixel included in the searched area. For example, the electronic device 101 may acquire the R value, G value, and B value of each pixel included in the analysis region (e.g., the entire region or searched region) of the content, and identify the largest value among all acquired R values, G values, and B values as the maximum value. For example, the electronic device 101 may compare the RGB sum of each pixel in the content analysis region, identify the pixel having the largest sum, and identify the largest value among the R, G, and B values of the identified pixel as the maximum value.

The electronic device 101 may compare the maximum value of RGB of the content with the RGB values of the third reference table 13a at operation 840. For example, when the size of the content is equal to or larger than the second size (e.g., 40% of the entire screen area), the electronic device 101 may compare the maximum value of the RGB of the content to the RGB values of the third reference table 13a. The electronic device 101 may compare the RGB value corresponding to the detected ambient illuminance among the RGB values in the third reference table 13a with the maximum value of RGB of the content. For example, as shown in FIG. 8B, if the detected ambient illuminance is approximately 100 lux, the corresponding RGB values in the third reference table 13a may be 15, 15, and 15, respectively, and if the detected ambient illuminance is approximately 1000 lux, the corresponding RGB values in the third reference table 13a may be 41, 41, and 41, respectively. If the detected ambient illuminance is about 3000 lux or more, the periphery of the electronic device 101 may be a very bright place (e.g., an outdoor place on a sunny day). The RGB values 0, 0, and 0 51 corresponding to the ambient illuminance of about 3000 lux or more in the third reference table 13a may indicate the deletion of the background image. The electronic device 101 may compare the maximum value of the RGB value of the content and the RGB values included in the third reference table 13a.

If the maximum value of RGB of the content is greater than the RGB value of the third reference table 13a at operation YES in 840, the electronic device 101 may reduce the RGB value of the content by the difference between the RGB value of the third reference table 13a and the RGB value of the content at operation 850.

FIG. 8C illustrates fifth content 61 having a second size or larger. For example, the fifth content 61 may have almost the same size as the screen size. The electronic device 101 may compare the identified maximum value of RGB of the fifth content 61 with the RGB value of the third reference table 13a and acquire a difference value. As an example, if the ambient illuminance is about 10 lux, the electronic device 101 may acquire the difference between RGB value 15 of the third reference table 13a and the identified maximum value of the RGB of the fifth content 61 as a difference value, and if the ambient illuminance is about 1000 lux, the electronic device 101 may acquire the difference between RGB value of the third reference table 13a and the identified maximum value of RGB of the fifth content 61 as a difference value. The electronic device 101 may adjust the brightness of the fifth content 61 by applying the difference value to the RGB value of the fifth content 61. If the electronic device 101 enters the AOD mode, the electronic device 101 may display the fifth content 62 and 63, the RGB values of which have been adjusted, as always-on-display content. As the ambient illuminance becomes higher, the RGB values in the third reference table 13a increase, and the adjusted RGB values of the fifth content 61 may thus decrease. Therefore, the brightness of the fifth content 62, the RGB values of which have been adjusted, may increase relatively in a high luminance and decrease relatively in a low luminance.

If the maximum value of RGB of the content is smaller than the RGB value of the third reference table 13a at operation NO in 840, the electronic device 101 may maintain the RGB value of the content at operation 860.

FIG. 8D illustrates sixth content 66 having a second size or larger. For example, the sixth content 66 may have a size almost equal to the screen size. The electronic device 101 may compare the identified maximum value of RGB of the sixth content 66 with the RGB values of the third reference table 13a and may acquire a difference value. As an example, if the ambient illuminance is about 10 lux, the electronic device 101 may acquire the difference between the RGB value 15 of the third reference table 13a and the identified maximum value of RGB of the sixth content 66 as the difference value, and if the ambient illuminance is about 1000 lux, the electronic device 101 may acquire the difference between the RGB value of the third reference table 13a and the identified maximum value of RGB of the sixth content 66 as the difference value. If the maximum value of RGB of the content is smaller than the RGB value of the third reference table 13a, the electronic device 101 may maintain the RGB value of the sixth content 66. Therefore, the sixth content 67 and 68 displayed in the AOD mode may be displayed with a similar brightness at a high luminance and a low luminance.

As an example, if the area of the content is equal to or larger than the second size and the ambient illuminance is very high (for example, 3000 lux or more), the electronic device 101 may not display the sixth content 66 (or the background image).

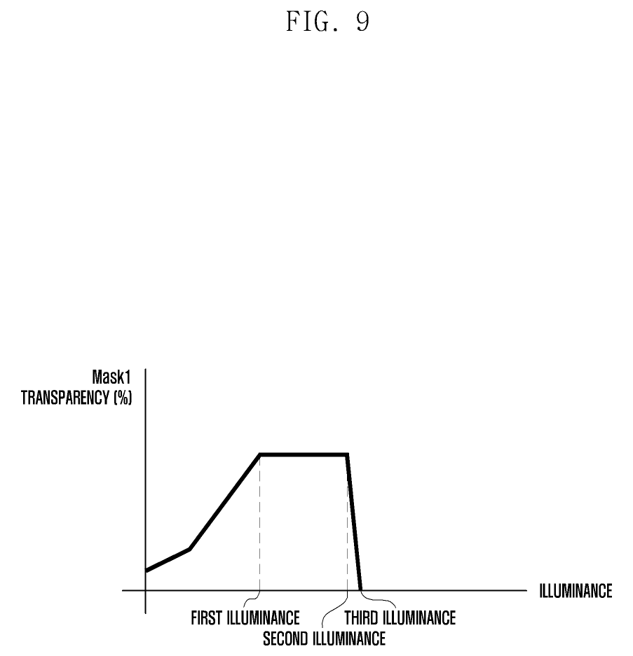

FIG. 9 is a diagram for describing the relationship between the ambient illuminance and the transparency of a mask according to an embodiment of the disclosure.

The electronic device 101 may have a mask, the transparency of which corresponds to the ambient illuminance, on a background image (or content). For example, the transparency of the mask may increase until the first illuminance and be maintained at a constant (or nearly similar) value until the second illuminance. The transparency of the mask may decrease from the second illuminance to the third illuminance, and may be opaque in the case of an illuminance higher than the third illuminance. If the background image is masked with a mask having a low transparency, the brightness of the background image may be decrease, and if the background image is masked with a mask having a high transparency, the brightness of the background image may increase.

In other words, the electronic device 101 may increase the brightness of the displayed background image (e.g., increase the transparency of the mask) in accordance with an increase in the ambient illuminance up to the first illuminance, and may maintain the brightness of the displayed background image (e.g., maintain the transparency of the mask) up to the second illuminance. Furthermore, the electronic device 101 may reduce the brightness of the displayed background image (e.g., reduce the transparency of a mask) in accordance with an increase in the ambient illuminance until the third illuminance, and may not display the background image after the third illuminance (e.g., mask the background image with an opaque mask).

As an example, in an ultra-low illuminance environment (e.g., a dark room), the electronic device 101 may further darken the background image (e.g., mask the background image with a low-transparency mask) in order to prevent light reflection. The electronic device 101 may brighten the background image (e.g., mask the background image with a specific-transparency mask) in a normal illuminance environment (e.g., indoors) to ensure the visibility of the background image. The electronic device 101 may remove the background image ((e.g., mask the background image with an opaque mask) in a high illuminance environment (for example, outdoors), thereby reducing power consumption.

As an example, the electronic device 101 may store, in the memory 130, a transparency table including the transparency of a mask associated with the ambient illuminance. The transparency table may include multiple transparency tables each including a different value of transparency according to the area of the content.

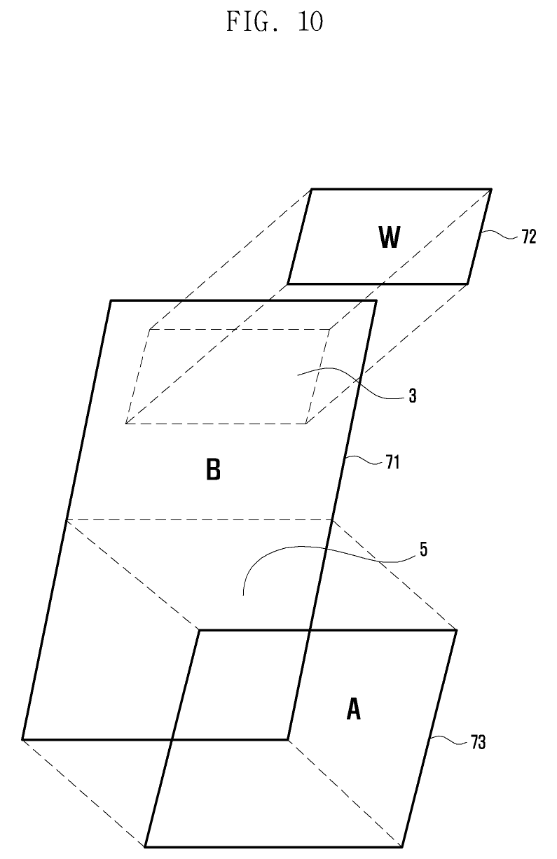

FIG. 10 is a diagram for describing a method for displaying multiple pieces of content according to an embodiment of the disclosure.

Referring to FIG. 10, a screen for displaying three pieces of content 71, 72, and 73 is illustrated. For example, the first content 71 may be a background image, the second content 72 may be a widget displayed above the background image, and the third content 73 may include an application displayed above the background image. Respective pieces of content 71, 72, and 73 may be displayed as different layers.

For example, the first content 71 (e.g., a background image) may be included in a first layer having a first area. The area of the first layer may be equal to the area of the screen. The second content 72 (e.g., a widget) may be included in the second layer of the second area. The third content 73 (e.g., an application) may be included in the third layer of the third area. The size (or area) of the first content 71 may be the area of the first layer, the size of the second content 72 may be the area of the second layer, and the size of the third content 73 may be the area of the third layer. The second content 72 may be located in the second region 3 on the first content 71, and the third content 73 may be located in the third region 5 on the first content 71.

The second content 72 included in the second layer and/or the third content 73 included in the third layer may be moved as the layers move. In addition, if the second and third layers are positioned to overlap each other, the second content 72 and the third content 73 may also be positioned to overlap each other.

The electronic device 101 may identify the maximum value of RGB of each content based on the layer, and adjust the RGB value of the content. For example, the electronic device 101 may identify the area of each of the first content 71, the second content 72, and the third content 73. The electronic device 101 may identify the maximum value among RGB values of the first content 71, identify the maximum value among RGB values of the second content 72, and identify the maximum value among RGB values of the third content 73.

The electronic device 101 may acquire a first difference value between the RGB value corresponding to the ambient illuminance in a reference table corresponding to the area of the first content 71 and the identified maximum value of the RGB value of the first content 71. In addition, the electronic device 101 may acquire a second difference value related to the RGB value of the second content 72, based on a reference table corresponding to the area of the second content 72, and may acquire a third difference value related to the RGB value of the third content 73, based on a reference table corresponding to the area of the third content 73.

The electronic device 101 may adjust the RGB value of the first content 71, based on the first difference value, adjust the RGB value of the second content 72, based on the second difference value, and adjust the RGB value of the third content 73, based on the third difference value.

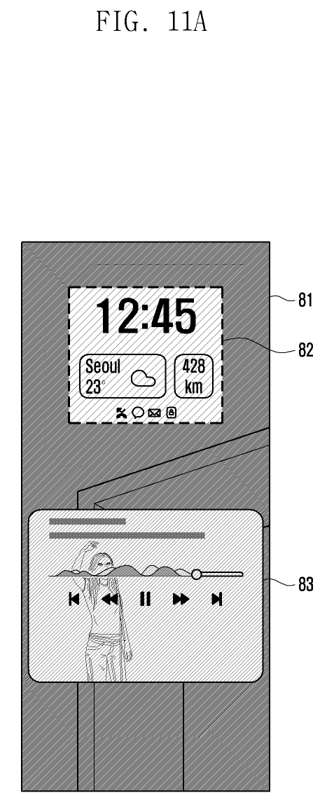

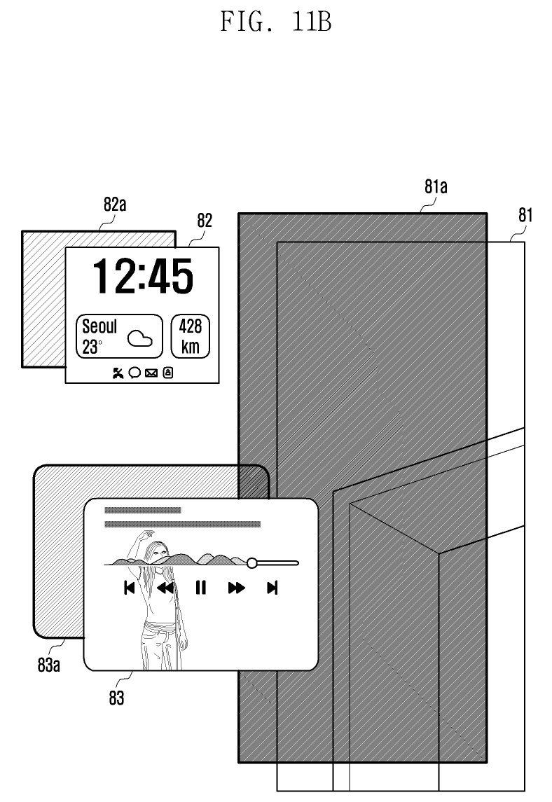

FIGS. 11A and 11B are diagrams for describing a method for masking multiple pieces of content according to various embodiments of the disclosure.

Referring to FIG. 11A, the electronic device 101 may display first content 81, second content 82, and third content 83. As an example, the first content 81 may be a background image, the second content 82 may be a widget, and the third content 83 may be an application. The first content 81 may be displayed on a first layer of a first area, the second content 82 may be displayed on a second layer of a second area, and the third content 83 may be displayed on a third layer of a third area.

FIG. 11B illustrates multiple pieces of content 81, 82, and 83 masked with corresponding masks 81a, 82a, and 83a. For example, the first content 81 (e.g., a background image) may be included in a first layer of a first area. The second content 82 (e.g., a widget) may be included in a second layer of a second area. The third content 83 (e.g., application) may be included in a third layer of a third area. The first content 81 may be masked with a first mask 81a of a first area, the second content 82 may be masked with a second mask 82a of a second area, and the third content 83 may be masked with a third mask 83a of a third area. Each of the masks 81a, 82a, and 83a may include a transparency corresponding to the detected ambient illuminance. If the detected ambient illuminance is equal to or higher than a preconfigured value, the transparency of the first mask 81a may be about 0% (for example, opaque).

If the electronic device 101 includes multiple transparency tables including different values of transparency according to the area of content, the transparency of respective masks 81a, 82a, and 83a may be different from one another even in the same ambient illuminance.

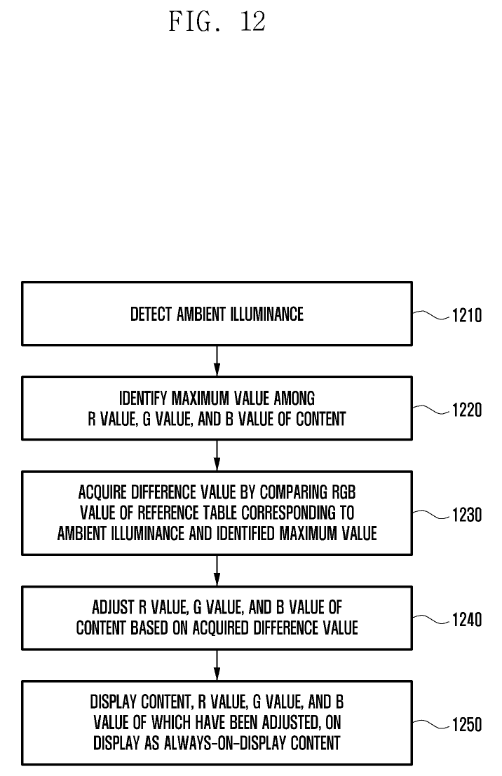

FIG. 12 is a flowchart illustrating a method for controlling the brightness of always-on-display content according to an embodiment of the disclosure.

In the following embodiments, respective operations may be performed in sequence, but are not necessarily performed in sequence. For example, the order of respective operations may be changed, and at least two operations may be performed in parallel.

According to an embodiment, operations 1210 to 1250 may be understood as being performed by a processor (e.g., the processor 120 in FIG. 2) of an electronic device (e.g., the electronic device 101 in FIG. 2).

Referring to FIG. 12, the electronic device 101 may detect the ambient illuminance at operation 1210. In addition, the electronic device 101 may identify the maximum value among the red (R), green (G), and blue (B) values of the content at operation 1220. For example, if the content includes a single color, the electronic device 101 may identify the color code of the content, and determine the RGB value of the identified color code as the RGB value of the content. In addition, the electronic device 101 may identify the largest value among the determined RGB values as the maximum value. As an example, if the content includes multiple colors, the electronic device 101 may identify the RGB values of each pixel of the content. In addition, the electronic device 101 may identify the largest value among all identified RGB values as the maximum value of the content RGB value.

The electronic device 101 may acquire a difference value by comparing the RGB value of a reference table corresponding to the detected ambient illuminance and the identified maximum value at operation 1230. For example, the reference table may include multiple reference tables including different RGB values according to the area (or size) of the content. The electronic device 101 may identify the area of the content. The electronic device 101 may determine, based on the identified content area, one reference table corresponding to the area of the identified content, among multiple reference tables. In addition, the electronic device 101 may determine an RGB value corresponding to the ambient illuminance included in the determined reference table. The electronic device 101 may compare the determined RGB value of the reference table and the maximum value of the identified content, and acquire a difference value.

The electronic device 101 may adjust the R value, G value, and B value of the content, based on the acquired difference value at operation 1240. For example, if the maximum value of RGB of the content is greater than the RGB value of the reference table, the electronic device 101 may reduce the RGB value of the content by the difference between the RGB value of the reference table and the RGB value of the content. If the maximum value of the RGB of the content is smaller than the RGB value of the reference table, the electronic device 101 may increase the RGB value of the content by the difference between the RGB value of the reference table and the RGB value of the content. As an example, if the area of the content is equal to or larger than a preconfigured size, and if the maximum value of RGB of the content is larger than the RGB value of the reference table, the electronic device 101 may maintain the R value, G value, and B value of the content.

For example, the content may include multiple pieces of content displayed as different layers. The electronic device 101 may identify the maximum value of RGB values of each piece of content, and acquire the difference value with regard to each piece of content, based on the reference table corresponding to the area of each piece of content. The electronic device 101 may adjust the RGB value of each piece of content, based on the difference values acquired with regard to each piece of content.

The electronic device 101 may display the content, the R value, G value, and B value of which have been adjusted, on the display as always-on-display content at operation 1250. For example, the electronic device 101 may mask the background image (or content) with a mask having a transparency corresponding to the detected ambient illuminance. If the detected ambient illuminance is equal to or higher than a preconfigured value, the electronic device 101 may mask the background image with an opaque mask (e.g., 0% transparency). If the electronic device 101 includes multiple pieces of content, the electronic device 101 may mask each piece of content with a mask having a corresponding size.

For example, the electronic device 101 may maintain the position of the displayed content if the detected ambient illuminance is equal to or less than a preconfigured value, and may move the displayed content by a preconfigured distance at a preconfigured time interval if the detected ambient illuminance is equal to or higher than the preconfigured value. As an example, if the detected ambient illuminance is less than about 500 lux, the electronic device 101 may not move the always-on-display content, and if the detected ambient illuminance is about 500 lux or more, the electronic device 101 may move the always-on-display content by a preconfigured distance at a preconfigured time interval.

As an example, the method for controlling the brightness of the always-on-display content may detect the ambient illuminance. The method may perform an operation of identifying the maximum value among the red (R) value, green (G) value, and blue (B) value of the content. The method may acquire a difference value by comparing the RGB value of a reference table corresponding to the detected ambient illuminance with the identified maximum value. The method may adjust the R value, G value, and B value of the content, based on the acquired difference value. The method may display the content, the R value, the G value, and the B value of which have been adjusted, on the display 160 as always-on-display content.

As an example, the method may identify the area of the content. The reference table may include multiple reference tables including different RGB values according to the area of the content. The operation of acquiring the difference value may determine one reference table corresponding to the identified area of the content among the multiple RGB tables. The operation of acquiring the difference value may compare the RGB value of the determined reference table with the identified maximum value to acquire the difference value.

As an example, the adjusting operation may maintain the R, G, and B values of the content if the area of the content is equal to or larger than a preconfigured size, and if the identified maximum value exceeds the RGB value of the reference table.

As an example, the content may include multiple pieces of content displayed as different layers. The operation of identifying the maximum value may identify the maximum value among the R value, the G value, and the B value with regard to each of the multiple pieces of content. The operation of acquiring the difference value may acquire a difference value by comparing the RGB value of a reference table corresponding to the identified area of the content and the identified maximum value with regard to each of the multiple pieces of content. The adjusting operation may adjust the R value, the G value, and the B value, based on the acquired difference value, with regard to each of the multiple pieces of content.

As an example, in the operation of identifying the maximum value, if the content includes a single color, the color code of the single color may be identified. The operation of identifying the maximum value may identify the maximum value among the R value, the G value, and the B value of the identified color code.

As an example, the method may mask the background image with a mask having a transparency corresponding to the detected ambient illuminance.

As an example, in the masking operation, if the detected ambient illuminance is equal to or greater than a preconfigured value, the background image may be masked with an opaque mask.

As an example, the operation of displaying on the display 160 may maintain the location of the displayed content if the detected ambient illuminance is less than a preconfigured value. The operation of displaying on the display 160 may move the displayed content by a preconfigured distance at a preconfigured time interval if the detected ambient illuminance is equal to or higher than the preconfigured value.

As an example, the reference table may include RGB values of white color displayed according to the ambient illuminance and the luminance of the display 160.

As an example, the maximum value of the reference table may include a maximum value of RGB values at which burn-in of the display 160 is avoided.

As an example, the electronic device 101 may include a sensor 176 for detecting ambient illuminance, a display 160, at least one processor 120, and memory 130 for storing instructions executed by the at least one processor 120. The instructions stored in the memory 130 may cause the electronic device 101 to perform an operation of identifying a maximum value among the red (R) value, green (G) value, and blue (B) value of content. The instructions stored in the memory 130 may cause the electronic device 101 to perform an operation of comparing the RGB value of a reference table corresponding to the detected ambient illuminance with the identified maximum value to acquire a difference value. The instructions stored in the memory 130 may cause the electronic device 101 to perform an operation of adjusting the R value, G value, and B value of the content, based on the acquired difference value. The instructions stored in the memory 130 may cause the electronic device 101 to perform an operation of displaying the content, the R value, G value, and B value of which have been adjusted, on the display 160 as always-on-display content.

As an example, the reference table may include multiple reference tables having different RGB values according to the area of content. The instructions stored in the memory 130 may cause the electronic device 101 to perform the operation of identifying the area of the content. The instructions stored in the memory 130 may cause the electronic device 101 to perform an operation of determining one reference table corresponding to the identified area of the content from the multiple RGB tables. The instructions stored in the memory 130 may cause the electronic device 101 to perform an operation of comparing the RGB value of the determined reference table and the identified maximum value to acquire a difference value.

As an example, the instructions stored in the memory 130 may cause the electronic device 101 to perform an operation of maintaining the R value, G value, and B value of the content if the area of the content is equal to or larger than a preconfigured size and the identified maximum value exceeds the RGB value of the reference table.

As an example, the content may include multiple pieces of content displayed as different layers. The instructions stored in the memory 130 may cause the electronic device 101 to perform an operation of identifying the maximum value among the R value, the G value, and the B value with regard to each of the multiple pieces of content. The instructions stored in the memory 130 may cause the electronic device 101 to perform an operation of comparing RGB values of a reference table corresponding to the identified area of the content and the identified maximum value with regard to each of the multiple pieces of content to acquire a difference value. The instructions stored in the memory 130 may cause the electronic device 101 to perform an operation of adjusting the R value, the G value, and the B value, based on the acquired difference value, with regard to each of the multiple pieces of content.

As an example, the instructions stored in the memory 130 may cause the electronic device 101 to identify the color code of a single color, if the content includes a single color. The instructions stored in the memory 130 may cause the electronic device 101 to perform an operation of identifying the maximum value among the R value, G value, and B value of the identified color code.

As an example, the instructions stored in the memory 130 may cause the electronic device 101 to perform an operation of masking the background image with a mask of transparency corresponding to the detected ambient illuminance.

As an example, the commands stored in the memory 130 may cause the electronic device 101 to perform an operation of masking the background image with an opaque mask if the detected ambient illuminance is equal to or higher than a preconfigured value.

As an example, the instructions stored in the memory 130 may cause the electronic device 101 to perform an operation of maintaining the position of the displayed content if the detected ambient illuminance is less than a preconfigured value. The instructions stored in the memory 130 may cause the electronic device 101 to perform an operation of moving the displayed content by a preconfigured distance at a preconfigured time interval if the detected ambient illuminance is equal to or greater than the preconfigured value.

As an example, the reference table may include RGB values of white color displayed according to the ambient illuminance and the luminance of the display 160.

As an example, a non-transitory computer-readable storage medium in which a program for performing a method for controlling the brightness of always-on-display content is recorded may perform an operation of detecting ambient illuminance. The storage medium may perform an operation of identifying a maximum value among the red (R) value, green (G) value, and blue (B) value of the content. The storage medium may perform an operation of comparing RGB values of a reference table corresponding to the detected ambient illuminance with the identified maximum value to acquire a difference value. The storage medium may perform an operation of adjusting the R value, G value, and B value of the content, based on the acquired difference value. The storage medium may perform an operation of displaying the content, the R value, the G value, and the B value of which have been adjusted, on the display 160 as always-on-display content.

It should be appreciated that various examples of the disclosure and the terms used therein are not intended to limit the technological features set forth herein to particular examples and include various changes, equivalents, or replacements for a corresponding example. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it denotes that the element may be coupled with the other element directly (e.g., wiredly), wirelessly, or via a third element.

As used in connection with various examples of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an example, the module may be implemented in a form of an application-specific integrated circuit (ASIC).

Various examples as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an example, a method according to various examples of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various examples, each component (e.g., a module or a program) of the above-described components may include a single entity or multiple entities, and some of the multiple entities may be separately disposed in different components. According to various examples, one or more of the above-described components may be omitted, or one or more other components may be added. Alternatively or additionally, a plurality of components (e.g., modules or programs) may be integrated into a single component. In such a case, according to various examples, the integrated component may still perform one or more functions of each of the plurality of components in the same or similar manner as they are performed by a corresponding one of the plurality of components before the integration. According to various examples, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for controlling brightness of always-on-display content, the method comprising:
detecting ambient illuminance;
identifying a maximum value among a red (R) value, a green (G) value, and a blue (B) value of content;
acquiring a difference value by comparing an RGB value of a reference table corresponding to the detected ambient illuminance with the identified maximum value;
adjusting the R value, the G value, and the B value of the content, based on the acquired difference value; and
displaying the content, the R value, the G value, and the B value of which have been adjusted, as the always-on-display content on a display.

2. The method of claim 1, further comprising:
identifying the area of the content,
wherein the reference table includes multiple reference tables including different RGB values according to areas of the content, and
wherein, in the acquiring of the difference, one reference table corresponding to the identified area of the content is determined among the multiple RGB tables, and the difference value is acquired by comparing RGB values of the determined reference table with the identified maximum value.

3. The method of claim 2, wherein, in the adjusting, the R value, G value, and B value of the content are maintained in case that the area of the content is greater than or equal to a predetermined size and the identified maximum value exceeds RGB values of the reference table.

4. The method of claim 2,
wherein the content includes multiple pieces of content displayed as different layers,
wherein, in the identifying of the maximum value, the maximum value is identified among the R value, the G value, and the B value for each of the multiple pieces of content,
wherein, in the acquiring of the difference value, the difference value is acquired by comparing RGB values of a reference table corresponding to the identified area of the content and the identified maximum value for each of the multiple pieces of content, and
wherein, in the adjusting, the R value, the G value, and the B value are adjusted based on the acquired difference value for each of the multiple pieces of content.

5. The method of claim 1, wherein, in the identifying of the maximum value, in case that the content includes a single color, a color code of the single color is identified, and the maximum value is identified among an R value, a G value, and a B value of the identified color code.

6. The method of claim 1, further comprising masking a background image with a mask of transparency corresponding to the detected ambient illuminance.

7. The method of claim 6, wherein, in the making, the background image is masked with an opaque mask in case that the detected ambient illuminance is equal to or higher than a preconfigured value.

8. The method of claim 1, wherein, in the displaying of the content, the position of the displayed content is maintained in case that the detected ambient illuminance is equal to or less than a predetermined value, and the displayed content is moved by a predetermined distance at a predetermined time interval in case that the detected ambient illuminance is equal to or greater than the predetermined value.

9. The method of claim 1, wherein the reference table includes RGB values of white color displayed according to the ambient illuminance and the luminance of the display.

10. The method of claim 9, wherein the maximum value of the reference table includes the maximum value of RGB values at which burn-in of the display is avoided.

11. An electronic device comprising:
a sensor configured to detect ambient illuminance;
a display;
at least one processor; and
memory, comprising one or more storage media, storing instructions,
wherein the instructions, when executed by the at least one processor individually or collectively, cause the electronic device to:
identify a maximum value among a red (R) value, a green (G) value, and a blue (B) value of content,
acquire a difference value by comparing an RGB value of a reference table corresponding to the detected ambient illuminance with the identified maximum value,
adjust the R value, the G value, and the B value of the content, based on the acquired difference value, and
display the content, the R value, the G value, and the B value of which have been adjusted, as the always-on-display content on the display.

12. The electronic device of claim 11,
wherein the reference table includes multiple reference tables including different RGB values according to areas of content, and
wherein the instructions, when executed by the at least one processor individually or collectively, further cause the electronic device to:
identify the area of the content, and
determine one reference table corresponding to the identified area of the content is determined among the multiple RGB tables, and acquire the difference value by comparing RGB values of the determined reference table with the identified maximum value.

13. The electronic device of claim 12, wherein the instructions, when executed by the at least one processor individually or collectively, further cause the electronic device to maintain the R value, G value, and B value of the content in case that the area of the content is greater than or equal to a predetermined size and the identified maximum value exceeds RGB values of the reference table.

14. The electronic device of claim 12,
wherein the content includes multiple pieces of content displayed as different layers, and
wherein the instructions, when executed by the at least one processor individually or collectively, further cause the electronic device to:
identify the maximum value among the R value, the G value, and the B value for each of the multiple pieces of content,
acquire the difference value by comparing RGB values of a reference table corresponding to the identified area of the content and the identified maximum value for each of the multiple pieces of content, and
adjust the R value, the G value, and the B value, based on the acquired difference value for each of the multiple pieces of content.

15. The electronic device of claim 11, wherein the instructions, when executed by the at least one processor individually or collectively, further cause the electronic device to, in case that the content includes a single color, identify a color code of the single color and identify the maximum value among an R value, a G value, and a B value of the identified color code.

16. The electronic device of claim 11, wherein the instructions, when executed by the at least one processor individually or collectively, further cause the electronic device to mask a background image with a mask of transparency corresponding to the detected ambient illuminance.

17. The electronic device of claim 16, wherein the background image is masked with an opaque mask in case that the detected ambient illuminance is equal to or higher than a preconfigured value.

18. The electronic device of claim 11, wherein the position of the displayed content is maintained in case that the detected ambient illuminance is equal to or less than a predetermined value, and the displayed content is moved by a predetermined distance at a predetermined time interval in case that the detected ambient illuminance is equal to or greater than the predetermined value.

19. One or more non-transitory computer-readable storage media storing one or more computer programs including computer-executable instructions that, when executed by one or more processors of an electronic device individually or collectively, cause the electronic device to perform operations, the operations comprising:
detecting ambient illuminance;
identifying a maximum value among a red (R) value, a green (G) value, and a blue (B) value of content;
acquiring a difference value by comparing an RGB value of a reference table corresponding to the detected ambient illuminance with the identified maximum value;
adjusting an R value, a G value, and a B value of the content, based on the acquired difference value; and
displaying the content, the R value, the G value, and the B value of which have been adjusted, as always-on-display content on a display.

20. The one or more non-transitory computer-readable storage media of claim 19, the operations further comprising:
identifying the area of the content,
wherein the reference table includes multiple reference tables including different RGB values according to areas of the content, and
wherein, in the acquiring of the difference, one reference table corresponding to the identified area of the content is determined among the multiple RGB tables, and the difference value is acquired by comparing RGB values of the determined reference table with the identified maximum value.
